(19) United States
(12) Patent Application Publication
(10) Pub. No.: US 2012/0225959 A1
(43) Pub. Date: Sep. 6, 2012

(54) PROTON-CONDUCTIVE MEMBRANE

(75) Inventors: James R. Muller, Decatur, GA (US); John Scott Flanagan, Chamblee, GA (US); Timothy Schriefer, Troy, NY (US); Lazbourne A. Allie, McDonough, GA (US); Lonnie G. Johnson, Atlanta, GA (US)

(73) Assignee: EXCELLATRON SOLID STATE LLC, Atlanta, GA (US)

(21) Appl. No.: 13/039,796

(22) Filed: Mar. 3, 2011

(51) Int. Cl. C08J 5/22; C08K 3/32; B05D 5/12; C08L 79/08

(52) U.S. Cl. 521/27; 427/77

(57) ABSTRACT

An anhydrous, proton-conductive medium comprises a poly(amic acid)-based polyimide and at least one phosphorus compound from the group consisting of phosphorus oxides and phosphoric acids. The precursor solution for the polyimide is a mixture of a phosphorus oxide and a poly(amic acid). A suitable phosphorus oxide has the formula P₄O₁₀. A process for forming an anhydrous, proton-conductive membrane comprises mixing a phosphorus oxide in a poly(amic acid) solution to form a mixture, dispensing the mixture upon a support structure, and substantially drying the mixture. The mixture may then be cured.

### RELATED APPLICATIONS

Not applicable.

### STATEMENT REGARDING FEDERALLY SPONSORED RESEARCH OR DEVELOPMENT

Not applicable.

### TECHNICAL FIELD

This invention relates to electrolyte membranes for electrochemical devices, and more particularly, the invention relates to proton-conductive membranes for electrochemical cells.

### BACKGROUND OF THE INVENTION

Devices that convert one form of energy into another form of energy are useful while devices that convert other forms of energy into electrical energy are particularly useful due to the enormous demand for electrical energy for a wide range of uses. Chemical energy and heat energy are two types of energy that can be converted into electrical energy. An electrochemical cell is a type of device that converts other forms of energy into electrical energy. Electrochemical cells include concentration cells, battery-type cells and fuel cells.

A central element in typical electrochemical cells is an electrolyte medium. Electrochemical cells operate on principles of redox reactions in which electrodes made of dissimilar materials placed upon opposite sides of an electrolyte medium to produce an electrochemical potential. Under the thus induced potential, ions are conducted through the electrolyte medium and a complementary flow of electrons are conducted through an external circuit connected between the electrodes.

Hydrogen is a desirable energy-generating material to use in energy-conversion devices such as fuel cells and concentration cells because it is plentiful, is readily available, is inexpensive, is light-weight, is easy to use in redox reactions, does not generally produce hazardous by-products when used in conversion devices and yields a relatively high amount of electrical energy.

Generally in electrochemical cells that employ hydrogen, hydrogen is acts as the reducing agent (also what gets “oxidized”) in a redox reaction. Hydrogen's single electron is stripped from the hydrogen atom and becomes a part of a flow of electrons through an external circuit while, simultaneously, the remaining hydrogen ion, denoted by the symbol H+, which is a proton, is conducted through the electrolyte medium to meet an oxidant at the reduction site. One problem in generating electricity using hydrogen in a redox reaction in an electrochemical cell has been in obtaining an effective electrolyte medium. Solid-state polymers have evolved as an attractive electrolyte medium for proton conduction. These solid-state, polymer electrolyte mediums (PEM) for conducting protons are known alternatively as “polymer electrolyte membrane (PEM)”, “proton-exchange membranes (PEM),” “proton-conducting membranes (PCM)” and “proton-conductive membranes (PCM).” These terms are all used interchangeably to describe proton conducting membranes herein. The membrane is the electrolyte medium that permits and facilitates passage of the proton while inhibiting passage of electrons.

An electrolyte membrane that is often used in a hydrogen-oxygen fuel cell and that may also be considered the current standard for proton-conducting membranes in general and for fuel cells in particular is a polymer membrane sold and distributed by E. I. du Pont de Nemours and Company under the trademark Nafion®. Nafion® is a thermoplastic type of polymer. Although Nafion® polymer membrane is widely used as the PEM/PCM of choice for hydrogen-oxygen fuel cells, the product has characteristics that limit its effectiveness in several applications and in fuel cells in particular.

A limiting characteristic of the Nafion® polymer membrane is related to the elevated temperatures that are often present and often desired in fuel cells. Platinum is often used as a catalyst in fuel cells (and other energy-conversion devices). The efficiency of a fuel cell that utilizes platinum as a catalyst often can be enhanced by operating the fuel cell at an elevated temperature. Nafion® brand membrane typically has to be wet to function optimally with respect to conductivity and structural properties. Thus it cannot be used in cells or cell environments where temperature exceeds the boiling point of water (that is, 100° C.) where the water will vaporize. If the membrane is dries out, it is rendered ineffective. Thus it can be appreciated that new materials are needed to provide proton-conducting membranes capable of operating at temperatures above 100° C.

For an electrochemical cell using a conductive membrane, it is necessary to have an effective membrane-electrode assembly having minimum impedance wherein an effective ion conductive membrane is sandwiched between two effective electrodes. Ideally, an effective PCM is one that has high ion conductivity (minimum impedance) over a wide temperature range and not subject to a dry out phenomenon.

A limitation of existing PCMB is related to interfacial resistances between the electrodes and the ion conductive membrane. Interface impedance must be minimized so that the overall impedance of the MEA is minimized. Proper bonding of a PCM to the electrodes in one quality needed for minimized interface impedance.

On the other hand, interfacial resistances may be due to problems in gas diffusion through the electrodes and catalytic reaction sites. This interface type of problem is often associated with is generally referred to as the “triple phase boundary” (TPB) of the MEA. The triple phase boundary in a membrane-electrode assembly is the region in which three components of the electrochemical cell that are necessary for an effective reaction at an electrode are all present. Those three components are the electrolyte (conducting ions), the fuel (or oxidant), and the catalyst. A desirable triple phase boundary has all three components in sufficient quantity to facilitate a respective optimum oxidation or reduction reaction. Producing a membrane-electrode assembly that provides an effective triple phase boundary has been problematic.

It is also desirable to have a PCM that has high structural integrity such that it can withstand pressure differentials and allow for a variety of fuel cell construction methods. High pressure differentials are often encountered in concentration cells.

It can be appreciated that it would be useful to have a proton-conductive membrane that can operate effectively: (1) above and below the boiling point of water (100° C.) and (2) at low relative humidity at either low or high temperatures.

It can further be appreciated that it would be useful to have an effective membrane-electrode assembly (MEA) that incorporates such a PCM. It can also be appreciated that it would be useful to have such a PCM and MEA that can be easily produced with minimum impedances.

It can be still further appreciated that for energy-conversion devices it is desirable to have an electrolyte membrane which is durable, which high structural integrity, which is able to withstand substantial pressure differential between opposing sides of the cell and which is able to withstand a variety of often rigorous fuel cell construction methods.

### SUMMARY OF THE INVENTION

To overcome the limitations of past approaches, an embodiment of the present invention provides a proton-conductive medium that comprises an anhydrous substrate of a thermally-stable, mechanically-tough, and chemically-resistant polymer doped with phosphorus oxide.

According to one aspect of this embodiment, the polymer is from the polyimide group of polymers.

According to a further aspect of this embodiment, poly(amic acid) is a precursor of the polyimide.

According to another aspect of this embodiment of the invention, the phosphorus oxide is phosphorus pentoxide.

According to another embodiment of the present invention, an anhydrous proton-conductive medium is produced by doping a thermally-stable, mechanically-tough, and chemically resistant polymer with a phosphorus oxide and fabricating and curing a substantially planar structure from the resulting mixture. According to one aspect of this embodiment, the polymer is from the polyimide group of polymers. According to a further aspect of this embodiment, poly(amic acid) is a precursor of the polyimide. According to another aspect of this embodiment of the invention, the phosphorus oxide is phosphorus pentoxide.

According to another embodiment of the invention, a membrane-electrode assembly for an electrochemical device is formed from a membrane comprising a substrate of a predetermined polymer doped with a phosphorus oxide that is integrally formed with and disposed between opposing electrodes wherein each electrode is formed from at least one electrically-conductive slurry layer and at least one catalyst slurry layer. According to an aspect of this embodiment, each slurry is formed in part from the predetermined polymer doped with the phosphorus oxide.

### BRIEF DESCRIPTION OF THE DRAWINGS

FIG. 1 is a schematic illustration of a fuel cell having components in accordance with an embodiment of the present invention.

FIG. 2 is a schematic illustration of an electrode in accordance with an embodiment of the invention.

FIG. 3 is an exploded view of a membrane-electrode assembly in accordance with an embodiment of the invention.

FIG. 4 is a perspective illustration of the fully-formed membrane-electrode assembly of FIG. 3.

FIG. 5 is a Nyquist plot of testing of an embodiment of a proton-conductive membrane produced in accordance with the teachings of the invention.

### DETAILED DESCRIPTION

Embodiments of the present invention are described herein. The disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, at least some specific structural and functional details disclosed herein are not to be interpreted as limiting, but merely as a basis for the claims and as a representative basis for teaching one skilled in the art to variously employ the present invention.

Efforts have been undertaken to provide a PCM membrane that overcomes one or more of the limitations set forth above and particularly limitations with respect to operating temperatures. Limited results have been realized in efforts to produce a PCM that operates effectively at both relatively low temperatures, such as ambient temperatures of environments inhabited by humans (for example, about 25° C.), and relatively high temperatures, such as above 100° C. and even above 250° C.

Pu et al. formed a dry, proton-conducting polymer from 4,4′-oxydiphthalic anhydride and 4,4′-diamino-diphenyl ether. Films were formed by mixing this polymer with phosphoric acid (H₃PO₄) in N-methylpyrrolidone (NMP) and casting it onto a glass plate. However, the room temperature conductivity was relatively low, between 10⁻⁶ and 10⁻⁷ S/cm at 25° C. See Hong-ting Pu, Lei Qiao, Qi-zhi Liu, Zheng-long Yang, European Polymer Journal 41 (2005) 2505-2510.

Pu and Wang formed a dry, proton-conducting polymer from 4,4′-oxydiphthalic anhydride, 4,4′-diamino-diphenyl ether, H₃PO₄ and imidazole in NMP. Films were cast and proton conductivities of 10⁻⁴ S/cm at 120° C. were obtained. This result is an improvement over the results obtained by Pu et al. described in the immediately preceding paragraph wherein the same polymer was used but without imidazole; however, the conductivity obtained here by Pu and Wang is not as high as would be desirable, and imidazole is a relatively expensive chemical. See Hongting Pu, Dan Wang, Electrochimica Acta 51 (2006) 5612-5617.

Dotelli et al. formed a dry proton-conducting polymer from polydipropyl-phosphazenium di-H phosphate which was mechanically strengthened by the addition of the sulfonated copolymer formed from 1,4,5,8-naphthalenetetracarboxylic dianhydride, 2,2′-benzidinedisulfonic acid and 4,4′-diaminodiphenyl ether. They obtained a proton conductivity of between 10⁻² and 10⁻³ S/cm at 112° C. However, the material suffers from having a complex formulation and the mechanical properties are limited due to the use of a phosphazene polymer. See Giovanni Dotelli, Maria C. Gallazzi, Matteo Bagatti, Enzo Montoneri, Vittorio Boffa, Solid State Ionics 178 (2007) 1442-1450.

Tadanaga et al. formed a proton-conducting polymer/ceramic composite by filling a commercially available polymer resin of undisclosed composition (U-imide-varnish type C; Unitika Ltd.) with a phosphosilicate powder. They achieved a proton conductivity of 2.5×10⁻³ at 180° C., however, the conductivity degraded unless the material was kept in an atmosphere of water vapor to prevent crystallization of Si₅O(PO₄)₆. See Kiyoharu Tadanaga, Yoshiki Michiwaki,

Teruaki Tezuka, Akitoshi Hayashi, and Masahiro Tatsumisago, Journal of Membrane Science, In Press, Accepted Manuscript, Available online 11 Jul. 2008.

Prior attempts have not yielded a PCM that can effectively be operated at high and low temperatures, that has high structural qualities and that has low impedance.

### The Membrane

The invention teaches a solid-state membrane that is particularly useful and suitable as the ion-conducting medium in a redox-reaction based energy-conversion device or system. The membrane is anhydrous in that it does not naturally contain water. In addition, the membrane taught by the invention is operative and effective without the presence of water.

The membrane taught by the invention is an anhydrous substrate of a thermally-stable, mechanically-sound (that is, in particular, having high tensile strength), chemically-resistant polymer doped with phosphorus pentoxide.

Phosphorus oxide used in the invention may be one of several oxides of phosphorus. These oxides are represented by a chemical formula having the form PₓO_{y}, where x is an integer between 1 and 4, and y is an integer between 4 and 10. A phosphorus oxide that has been found to work particularly well is phosphorus pentoxide, also known as phosphorus (V) oxide and phosphoric anhydride. This compound is identified by the chemical formulas P₂O₅ (empirical formula) and P₄O₁₀ (the molecular formula). Sometimes for convenience and simplicity herein, only the empirical formula is used.

### Method of Producing Proton-conductive Membrane

The invention provides a high-performance, solid-state, proton-conductive membrane that is made by a process that combines a phosphorus oxide with a poly(amic acid) type of polymer to form a poly(amic acid)-and-phosphorus-oxide solution, which is then dried and cured to form an anhydrous, substantially-solid substrate. The process of dispersing a first substance in a second substance in order to provide a new substance with particular characteristics is often referred to as “doping” of the second substance. Poly(amic acid) is used as a precursor that when heated reacts to form polyimide. Phosphorus oxide typically is obtained in powdered form and is dissolved substantially completely in the poly(amic acid) solution. To promote substantially complete dissolution of phosphorus oxide, the phosphorus oxide is first dissolved in a solvent to form a phosphorus oxide solution, which is then mixed with the poly(amic acid) solution. A solvent is a constituent component of the poly(amic acid) solution. Thus to help facilitate mixing between the phosphorus-oxide solution and the poly(amic acid), a solvent that may be harmoniously used in the preparation of the poly(amic acid), that in turn is used to form the polyimide, is used to “pre-dissolve” the phosphorus oxide. For even greater ease of mixing, the exact same solvent that is used to dissolve the poly(amic acid) also is used to “pre-dissolve” the phosphorus oxide.

After the poly(amic acid)-phosphorus-oxide solution has been prepared, it is layered upon a supporting structure then dried to substantially remove liquid solvent. After drying, the product may be cured. The final product is an anhydrous, substantially-solid substrate that is used as a proton-conductive membrane.

The polyimide precursor used in the invention is based upon poly(amic acid). One poly(amic acid) of particular use for the invention is poly(pyromellitic dianhydride-co-4,4′-oxydianiline), amic acid, which when cured, transforms into poly(pyromellitic dianhydride-co-4,4′-oxydianiline).

In the invention, phosphorus oxide is substantially completely dissolved in poly(amic acid)/polyimide. Because phosphorus oxide typically exists in a powdered state, the invention also teaches dissolution of phosphorus oxide in a solvent prior to mixing with poly(amic acid). Pre-dissolution of phosphorus oxide in solvent facilitates a more thorough dissolution in the polymer. In the example of pre-dissolution detailed herein phosphorus oxide in the form of P₄O₁₀ was mixed in an NMP type of solvent in a 1:10 ratio by weight. However, the ratio can vary widely. The objective is to obtain dissolution of the solid phosphorus oxide in the chosen solvent to facilitate thorough mixing of the phosphorus oxide in the poly(amic acid). Lower solid content would dissolve easier in the solvent and the poly(amic acid) but then the doping content would be less and greater time and effort would have to be applied to remove liquid solvent from the solution to produce the final membrane.

Several solvents are suitable for pre-dissolving the phosphorus oxide including N-methylpyrrolidone, N,N-dimethylformamide, N,N-dimethylacetamide and N-ethylpyrrolidone. It is desirable to use a solvent that is compatible with the formulation of polyimide used. Poly(amic acid)-based polyimide is often made by known processes in which the poly(amic acid) precursor is dissolved in a solvent. The invention uses a solvent that is also used in the formation of the polyimide to promote compatibility among the constituent substances of the invention. For example, a brand of poly(amic acid) that is suitable for use in the invention is Pyre-ML®-RC5019. Pyre-ML®-RC5019 is distributed and sold by Industrial Summit Technology Corporation of New Jersey under the registered trademark Pyre-ML®. Information provided by the supplier identifies the product as poly(pyromellitic dianhydride-co-4,4′-oxydianiline), amic acid and indicates that the product contains the solvent N-methyl pyrrolidinone (NMP). The NMP solvent is used in a ratio wherein the solvent comprises about 85% by weight of the mixture. The invention teaches use of NMP as a suitable solvent for pre-dissolution of the phosphorus oxide. The invention teaches use of NMP as a solvent for the poly(amic acid) thereby promoting compatibility between the phosphorus oxide solution and the poly(amic acid) solution. The ratio of phosphorus oxide to poly(amic acid) or to the solvent can vary widely. In the example of production of a membrane detailed herein a pre-dissolved-phosphorus-oxide solution was mixed in a solvent in a ratio of about 1:2 by weight. The objective is to obtain a mixture in which the phosphorus oxide is fully dissolved. More phosphorus oxide produces greater doping and thus greater ionic conductivity. However, processing time and efficiencies are affected if too much or too little solid phosphorus oxide is used for efficient mixing, drying and curing.

The product of the phosphorus oxide and poly(amic acid) mixture taught by the invention is a polyimide and at least one phosphorus compound from the group consisting of phosphorus oxides and phosphoric acids. The polyimide of the exemplary embodiment produced from poly(pyromellitic dianhydride-co-4,4′-oxydianiline), amic acid and discussed herein is poly(4,4′-oxydiphenylene-pyromellitimide) polyimide. The phosphorus oxides have a formula PₓO_{y}, wherein x=1 to 4 and y=4 to 10. The phosphoric acids have a formula HO(P(O)(OH)O)ₙH where n is a positive integer. In particular, in an embodiment, n=1 to 10. And more narrowly, the phosphoric acids may have a formula HO(P(O)(OH)O)ₙH where n=1 to 4. And even more specifically, the phosphoric acid may be trimetaphosphoric acid having the formula H₃P₃O₉.

Method of Producing Proton-conductive Membrane—Example 1 of Production of Proton-conductive Membrane—The membrane taught by the invention may be produced in a variety of geometric shapes. A particularly useful shape taught by the invention is a substantially planar configuration. Such a configuration is useful for constructing a membrane-electrode assembly. The example of producing a membrane that follows focuses upon a substantially-planar end product; however, the teachings herein are equally applicable to other geometric configurations.

A quantity of phosphorus oxide, in the form of phosphorus pentoxide, P₄O₁₀, was substantially completely dissolved in a quantity of NMP solvent to create a phosphorus oxide solution. A suitable diluted solution was obtained by mixing P₄O₁₀ in NMP solvent in a 1:10 ratio by weight. Mixing was performed on a magnetic stirrer at 50° C. until the P₄O₁₀ was substantially completely dissolved in the solution. 5 g of the P₄O₁₀-NMP solution was then added to 10 g of Pyre-ML®-RC5019 brand poly(amic acid) (sometimes for convenience, both the polyimide polymer and the poly(amic acid) precursor are interchangeably referred to herein as “PI” wherein the “I” is a capital “i”) and mixed on a magnetic stirrer for at least 10 minutes. The poly(amic acid)-P₄O₁₀ solution (also referred to herein as “PI-P₄O₁₀ solution”) was then cast into a stainless steel mold and placed onto a hotplate to dry. The hotplate was maintained at 130° C. to allow a moderate removal of solvent in order to prevent cracking and wrinkling. After 1 hour on the hotplate the membrane was removed and placed between two flat aluminum plates. The plates were then placed in an oven at 150° C. for 2 hours to further remove all the solvent and initiate the curing process. The oven was heated at a ramp rate of 2.33° C./min to ensure slow removal of the remaining solvent, thus preventing cracking. To fully cure the membrane, it was further heated at 250° C. for at least 1 hour. Curing helped facilitate production of membranes with high mechanical integrity and low diffusion coefficient. Flexible, high strength, proton-conductive membranes having thicknesses ranging from 20 μm to 100 μm were obtained.

In an alternative version of the process, the membrane was formed by spin-coating the PI-P₄O₁₀ solution onto a glass substrate after which it was dried in a convection oven at 150° C. for 2 hours, followed by curing at 250° C. for 1 hour between aluminum plates.

Method of Producing Proton-conductive Membrane—Example 2 of Production of Proton-conductive Membrane—The material of the invention whether in planar membrane geometry or some other configuration can be made using a variety of formulation percentages. An objective of the invention is to mix the ingredients for forming the proton-conductive material in quantities that result in substantially thorough dissolution of the solid components. The following is a more detailed description of the example of production using percentages.

In this example, 103 grams of a solution containing a poly(amic acid) precursor, phosphorus pentoxide (P₄O₁₀) and N-methyl pyrrolidinone (NMP) was produced dried and cured to form proton-conductive material ultimately used as a membrane. A poly(amic acid) liquid sold under the brand name Pyre-ML®-RC5019 was obtained from Industrial Summit Technology Corporation (“IST”) of New Jersey. Product information provided by IST identifies the product as poly(pyromellitic dianhydride-co-4,4′-oxydianiline), amic acid and indicates that the product contains the solvent N-methyl pyrrolidinone (NMP) in a ratio wherein the solvent comprises about 85% by weight of the mixture. 8 grams of P₂O₅, a solid phase ingredient, was dissolved (pre-dissolved) in 80 grams of NMP (a 1:10 ratio) to produce a P₄O₁₀-NMP solution. 75 grams of the liquid poly(amic acid) was mixed with 28 grams of the P₄O₁₀-NMP solution to produce 103 grams of PI-P₄O₁₀ solution. Based upon the percentages discussed previously in this paragraph, the PI-P₄O₁₀ solution is calculated to comprise about 11.3 grams poly(amic acid), which is about 11% by weight of the PI-P₄O₁₀ solution; about 89.2 grams NMP, which is about 87% by weight of the PI-P₄O₁₀ solution; and about 2.5 grams P₄O₁₀, which is about 2% by weight of the PI-P₄O₁₀ solution.

### The Membrane: Use in Fuel Cell

Because the proton-conductive membrane taught by the invention is particularly useful in fuel cells as an energy-conversion device, an exemplary embodiment of a proton-conductive membrane and MEA incorporating same will be discussed in the context of a fuel cell.

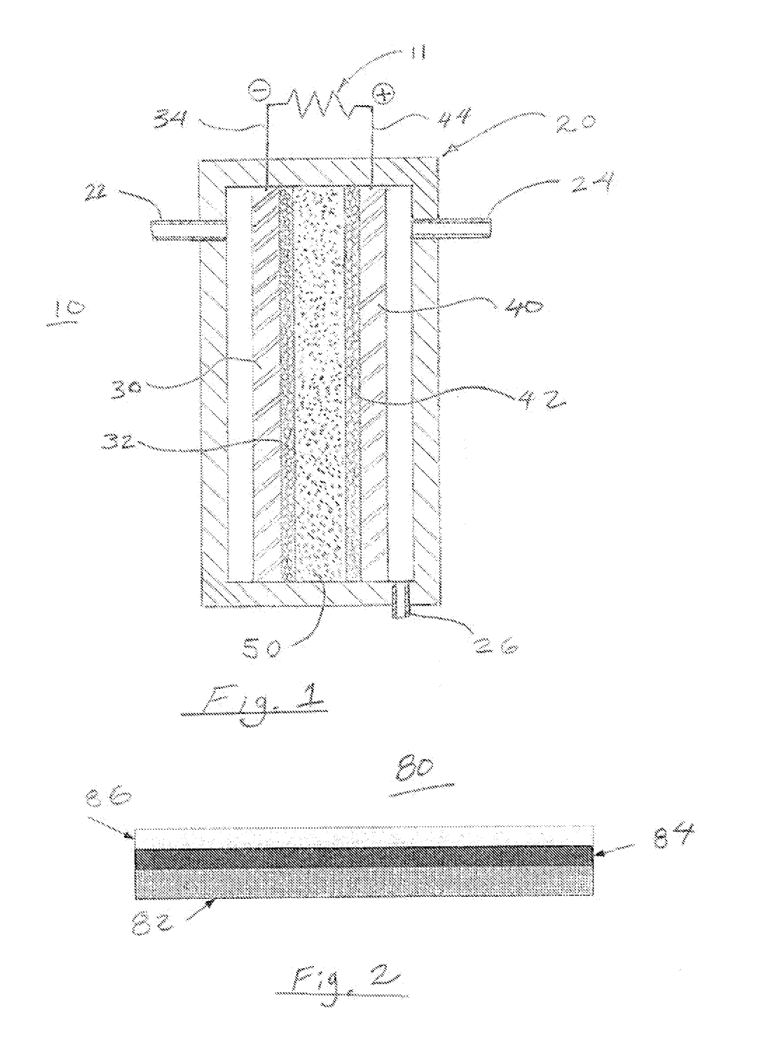

Referring to FIG. 1, therein is illustrated a fuel cell in which embodiments of proton-conductive membranes and membrane-electrode assemblies according to teachings of the invention may be incorporated. The illustration is a simplified schematic illustration in several respects. In particular, several of the elements such as electrodes, catalyst and membrane are shown as distinct features for illustrative purposes; however, the invention teaches an interrelated arrangement of these features wherein the boundaries in actuality are not so clearly delineated.

A fuel cell 10 is formed in part by and within a housing 20 or similar enclosure. Fuel inlets are on opposing sides of the housing 20. An inlet port 22 for infusion of hydrogen is disposed opposite an inlet port 24 for infusion of oxygen. An outlet port for release of water is disposed at a lower region of the housing 20. An electrode positioned as an anode 30 is disposed proximate the hydrogen inlet port 22. An electrode positioned as a cathode 40 is disposed proximate the oxygen inlet port 24. A first catalyst region 32 is disposed adjacent the anode 30. A second catalyst region 42 is disposed adjacent the cathode 40. A first electrical connector 34 positioned as a negative electrical terminal extends from the anode 30 exteriorly of the housing 20. A second electrical connector 44 positioned as a positive electrical terminal extends from the cathode 40 exteriorly of the housing 20. The electrical connectors 34, 44 are disposed to receive a circuit or similar electrical load 11 therebetween. An electrolyte, which may be in the form of a proton-conductive membrane in accordance with the teachings of the invention 50 is disposed between and adjoins the catalyst with anode 30/32 and the catalyst with cathode 40/42.

In one aspect, the invention enhances the effectiveness of an energy-conversion device, such as a fuel cell, by enhancing the effectiveness of the electrolyte component. In another aspect of the invention, the effectiveness of an energy-conversion device, such as a fuel cell, is enhanced by enhancing the effectiveness of electrodes to interact with the electrolyte of the invention and by providing a process for manufacturing such electrodes. As a further aspect of the invention, the effectiveness of an energy-conversion device, such as fuel cell, is enhanced by enhancing the effectiveness of a membrane-electrode assembly and by providing a process for assembling the membrane-electrode assembly.

### Electrodes and Membrane-Electrode Assembly (MEA)

In a fuel cell and other energy conversion devices, the electrolyte medium (that is, the membrane) is disposed between and generally adjoins spaced-apart electrodes. The invention employs its enhanced proton-conductive membrane in conjunction with fabricated electrodes to integrally form a membrane-electrode assembly (MEA) that enhances the interaction between electrolyte, electrodes and fuels (or fuel and oxidant).

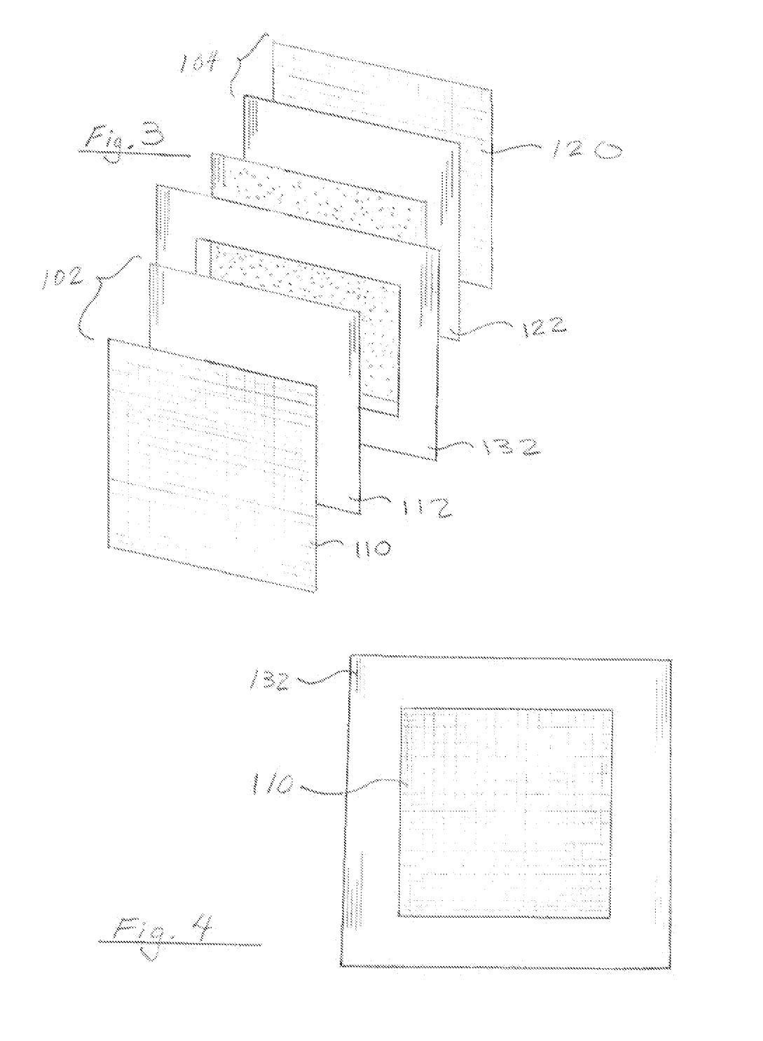

The membrane taught by the invention is particularly effective when attached to porous electrodes. Porous electrodes permit fluids, including gases, to permeate and flow through the electrodes. When used in a fuel cell, the porous electrodes help facilitate the flow of liquid and gaseous fuels (such as gaseous oxygen and hydrogen) through the electrodes to support the chemical reactions that generate electricity. A suitable porous electrode for joinder with the membrane that is taught by the invention is illustrated in the sectional schematic illustration of FIG. 2. As illustrated in FIG. 2, a porous electrode 80 comprises three layers 82, 84, 86. A carbon cloth substrate 82 supports a layer of carbon black 84. A layer of catalyst material 86 is disposed upon the carbon black layer 84.

The membrane taught by the invention is particularly useful when conjoined with electrodes to form a membrane-electrode assembly (MEA). The MEA aspect of the invention addresses a structural and operational characteristic of fuel cells known as “Triple Phase Boundaries.” This term is derived from the theory that the hydrogen oxidation reaction that occurs at the anode and the oxygen reduction reaction that occurs at the cathode each take place either predominantly or exclusively at regions of each electrode where the (1) electrolyte, the (2) fuel (hydrogen or oxygen gas), and the (3) catalyst are present. The intersection of these three constituents is often referred to as the Triple Phase Boundary.

Use of the novel proton-conductive material taught herein facilitates production of a membrane-electrode assembly having an effective triple phase boundary region. The membrane-electrode assembly formed provides a greater abundance of triple phase boundaries by at least partially integrally forming portions of an electrolyte\membrane medium (which incorporates the proton-conductive medium of the invention) with portions of an electrode\catalyst medium in a manner that optimizes infusion and permeation by gases (hydrogen or oxygen).

In an embodiment of the invention, substantially planar electrodes are attached to the membrane to form a substantially planar membrane-electrode assembly (MEA). The invention encompasses the preparation of the electrodes used to make the MEA and a method of bonding the electrodes to the membrane (PCM) taught by the invention.

In an aspect of the invention, the electrodes are formed from slurries created from particulate substance mixed with a binder. The slurries are used to provide electrode layers like those illustrated in FIG. 2. Referring again momentarily to FIG. 2, porous electrode components 80 for the embodiment of the membrane-electrode assembly that will be described below are formed as previously illustrated wherein the layer of carbon black 84 that is placed upon the carbon cloth 82 comprises a carbon-black slurry and the layer of catalyst 86 that is disposed upon the carbon-black layer 84 comprises a catalyst slurry. In an embodiment of a MEA and method of forming, the membrane taught by the invention is affixed between the porous electrodes.

Reference is now made to FIG. 3. FIG. 3 is an exploded view of a layered membrane-electrode assembly 100. The manner in which each layer is formed and applied, or simply applied is described below. It is to be noted that in the exploded view of FIG. 3, the layers are depicted as distinct; however, this manner of illustration is provided to facilitate an understanding of the MEA. As will be described in greater detail below, several of the layers may be formed in a manner wherein a layer is not distinctly formed before alignment with other layers but instead is applied as a slurry to a previously disposed layer.

In FIG. 3, the foundation for each porous electrode portion 102, 104 of the

MEA is a carbon cloth having carbon black applied thereto. In the schematic illustration of FIG. 2, these features are shown as distinct layers 82, 84. However, in FIG. 3, the carbon cloth with carbon-black slurry applied thereto is shown as a single layer element 110, 120 at each end of the exploded MEA. A catalyst layer 112, 122, although it may be formed as a slurry and applied to the carbon cloth-carbon black layer 110, 120, is shown for illustrative purposes as a distinct layer. The electrolyte layer 130, in the form of a proton-conductive membrane as taught herein, is sandwiched between the electrode portions 102, 104. A gasket 132 is used to ensure separation between the electrode portions 102, 104.

Although many different types of binder may be used to make the slurries, the invention teaches use of a binder that will form an electrode that is compatible with the membrane of the invention. Thus the invention teaches use of the same poly(amic acid)-and-phosphorus-oxide solution that is used to form the membrane as a binder to make the slurries. Carbon black (“CB”) is used as effective current-conductive particulate matter for mixing with the binder.

Example of Process for Forming Electrodes and Producing Membrane-Electrode Assembly—An example of a process for making the electrodes and MEA as taught by the invention follows. Reference is again made to FIG. 3 to aid in describing the example. Each electrode 102, 104 was formed from carbon cloth and two slurries. A first slurry, for forming the basic electrode layer, was prepared by mixing suitable quantities of carbon black (CB) with a binder. To produce an electrode that was compatible with the membrane taught by the invention, the PI-P₄O₁₀ solution previously described herein was used as binder. For convenience the first slurry is referred to herein as “CB slurry.” Many different ratios of CB to binder would produce slurries of adequate consistency to be layered as further described herein. However, a ratio of 1:4 parts by weight CB to PI-P₄O₁₀ solution was used and found to be particularly suitable for forming a first slurry (the CB slurry) of effective consistency.

A second slurry, for forming the catalyst layer of the electrode, was prepared by mixing platinum-coated carbon black (“PtCB”) and binder. To promote compatibility between electrode and membrane, again PI-P₄O₁₀ solution was used as binder. For convenience the second slurry is referred to herein as “PtCB slurry.” Many different ratios of PtCB to binder would produce slurries of adequate consistency to be layered as further described herein. However, a ratio of 1:3 parts by weight PtCB to PI-P₄O₁₀ solution was used and found to be particularly suitable for forming a second slurry (the PtCB slurry) of effective consistency.

The CB slurry was cast onto a carbon cloth then partially dried at 130° C. In FIG. 3, each closely-formed carbon cloth and CB slurry feature is denoted by numerals 110 and 120. The carbon cloth serves as a support that is both a gas-diffusion layer and a current collector. The PtCB slurry was cast on top of the partially-dried CB slurry. Each catalyst layer is depicted as a distinct feature denoted by numerals 112 and 122 in the exploded view. The resulting layered structure was then partially dried. A quantity of PI-P₄O₁₀ solution (that is, the membrane solution) was evenly applied to (cast upon) the PtCB face of each electrode and then partially dried. This application of PI-P₄O₁₀ solution was applied to facilitate joinder of the membrane layer 130 with each catalyst layer 112, 122.

As some of the solvent was removed through drying, and as drying in general advanced, a preformed gasket 132 was disposed upon the inner face (that is, the face opposite the carbon cloth) of one of the electrodes. The gasket 132 was used to ensure separation of the electrode layers 110/112 and 120/122 from one another. The gasket may be made from many different non-conductive substrates. High-temperature-resistant polymer material was used for the gasket to maintain overall consistency with the constituent substances of the membrane and electrodes. The gasket 132 used was made from a polymer resin sold and distributed under the product name Matrimid® 9725. Matrimid® 9725 is a product of Huntsman Advanced Materials Inc. believed to be based in The Woodlands, Tex. The product is a high-temperature thermoplastic polyimide. Alternatively the gasket can be made from any high-temperature thermoplastic polymer. The other electrode was placed upon the open side of the gasket 132 to complete the MEA. The fully-formed MEA structure was then left to dry at 130° C. on a hotplate drying apparatus, after which it was removed and placed in an oven at 260° C. for 1 hour to cure the proton-conductive membrane (PCM).

FIG. 4 illustrates a fully-assembled membrane-electrode assembly 100 in which the carbon cloth backing of the cloth-CB feature 110 and gasket 132 are shown.

### Alternate Method of Forming MEA

As an alternative to the example of assembly described, the MEA can be made by methods such as spraying and hot pressing. A catalyst ink rather than a catalyst slurry 112, 122 can be made and sprayed onto each side of the membrane 130. The sprayed catalyst ink is then partially dried at 70° C. in a convection oven for 2 hours. The gas diffusion layer (GDL) 110, 120 comprising carbon cloth and carbon black (CB) is then attached to the membrane containing the catalyst by hot pressing to fully form the MEA.

### Testing Proton-Conductive Membrane as Taught by the Invention

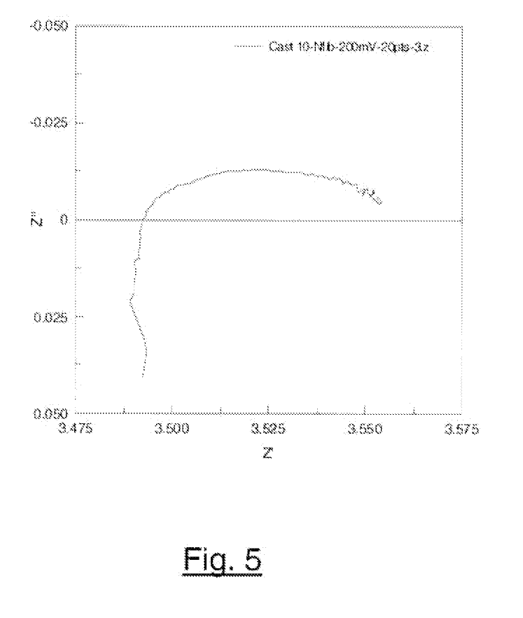

FIG. 5 shows the Nyquist plot of the PCM bonded to electrodes and tested in hydrogen. It shows an ionic resistance of about 3.85 ohms, which translates to proton conductivity of the membrane of the order of 10⁻³ S/cm. The conductivity of the order of 10⁻³S/cm was recorded when the membrane was tested in hydrogen at room temperature for more than six hours. It is to be noted that if the thickness of the membrane is reduced and the temperature in which it is tested is increased, the membrane's conductivity can be greatly enhanced. The plot also shows a low interfacial resistance between the PCM and the electrodes. This is reflected by the size and character of the loop formed by the semicircle of the graph. A larger and/or more pronounced loop would indicate greater resistance.

A solid state, proton-conductive membrane is developed from a polyimide doped with phosphorus pentoxide. Polyimide is used because of its desirable mechanical and thermal stabilities as well as chemical resistance. These properties permit operation of the proton-conducting membrane at high temperatures without losing its conductivity, while at the same time increasing the efficiency of fuel cells or other solid state devices and decreasing the degradation of the catalyst layer, which usually occurs at low temperatures. The invention uses phosphorus oxide to dope the polyimide polymer. Phosphorus oxide imparts the membrane with the ability to effectively transport protons without the need for moisture. Thus a membrane formed as taught by the invention can effectively operate in environments having very low humidity.

Membranes produced through the teachings of the invention are both rugged and highly conductive. The invention provides a solid-state membrane that maintains high proton conductivity in dry hydrogen. Because of the polyimide polymer base employed, the membrane has several advantageous characteristics, particularly for use in electrochemical devices such as fuel cells. The membrane of the invention is mechanically strong. In addition, the membrane is stable at high temperatures (above 300° C.) and has excellent mechanical integrity throughout an extended range of temperatures, particularly at the elevated levels of temperature at which a fuel cell operates. Polyimide polymer that is used as a primary constituent of the membrane and electrodes of the invention is a thermoset polymer that possesses structural integrity and soundness throughout a range of temperatures including elevated temperatures.

Although the invention has been described in the context of constructing a fuel cell, the membrane and the teachings of the invention are also applicable to and intended to encompass other energy-conversion devices including but not limited to battery type cells, thermal engines and heat pumps.

The invention disclosed herein addresses shortcomings of the prior art by providing a proton-conducting membrane with high proton conductivity over a wide temperature range and that remains thermally and mechanically stable at these temperatures. The invention also provides a more economical and effective electrode than those previously used, and addresses the Triple-Phase

Boundary (TPB) problem by creating a novel method of bonding the electrodes to the proton-conductive membrane (PCM).

Although the invention and the problems addressed by the invention have been described in the context of a proton-conductive membrane, a membrane electrode assembly, electrochemical cells in general and a fuel-cell type of electrochemical cell in particular, more generally, the invention teaches a proton-conductive material. The material is a medium that conducts protons. The proton-conductive material may be produced and used in configurations other than a membrane that is suitable for use as a substantially planar member or substrate in a fuel cell. The proton-conductive material, or medium, taught by the invention may be produced in many different configurations. Geometric configurations other than planar are consistent with the teachings herein.

Many variations and modifications may be made to the above-described embodiments without departing from the scope of the claims. All such modifications, combinations, and variations are included herein by the scope of this disclosure and the following claims.

What is claimed is:

1. An anhydrous, proton-conductive medium comprising a poly(amic acid)-based polyimide polymer and at least one phosphorus compound from the group consisting of phosphorus oxides and phosphoric acids.

2. The anhydrous, proton-conductive medium of claim 1, wherein said phosphorus oxides have a formula PₓO_{y}, wherein x=1 to 4 and y=4 to 10.

3. The anhydrous, proton-conductive medium of claim 1, wherein said phosphoric acids have a formula HO(P(O)(OH)O)ₙH where n is a positive integer.

4. The anhydrous, proton-conductive medium of claim 1, wherein said phosphoric acids have a formula HO(P(O)(OH)O)ₙH where n=1 to 10.

5. The anhydrous, proton-conductive medium of claim 1, wherein said phosphoric acids have a formula HO(P(O)(OH)O)ₙH where n=1 to 4.

6. The anhydrous, proton-conductive medium of claim 1, wherein said phosphoric acids comprise trimetaphosphoric acid.

7. An anhydrous, proton-conductive medium comprising a phosphorus-oxide-doped poly(amic acid)-based polyimide polymer substrate.

8. The anhydrous, proton-conductive medium of claim 7, wherein said poly(amic acid) is an aromatic poly(amic acid).

9. The anhydrous, proton-conductive medium of claim 7, wherein said poly(amic acid) is an aliphatic poly(amic acid).

10. The anhydrous, proton-conductive medium of claim 7, wherein said phosphorus oxide has the formula PₓO_{y}, with x=1 to 4 and y=4 to 10.

11. The anhydrous, proton-conductive medium of claim 7, wherein said phosphorus oxide has the formula P₄O₁₀.

12. An anhydrous, proton-conductive medium formed by a process comprising:
mixing a phosphorus oxide in a poly(amic acid) solution to form a mixture;
dispensing said mixture upon a support structure; and
substantially drying said mixture.

13. The anhydrous, proton-conductive medium of claim 12, further comprising curing said mixture after drying.

14. The anhydrous, proton-conductive medium of claim 12, wherein said poly(amic acid) is an aromatic poly(amic acid).

15. The anhydrous, proton-conductive medium of claim 12, wherein said poly(amic acid) is an aliphatic poly(amic acid).

16. The anhydrous, proton-conductive medium of claim 12, wherein said phosphorus oxide has the formula PₓO_{y}, with x=1 to 4 and y=4 to 10.

17. The anhydrous, proton-conductive medium of claim 12, wherein said phosphorus oxide has the formula P₄O₁₀.

18. The anhydrous, proton-conductive medium of claim 12, wherein the step of mixing a phosphorus oxide in a poly(amic acid) solution to form a mixture comprises first pre-dissolving said phosphorus oxide in a poly(amic acid)-compatible solvent.

19. The anhydrous, proton-conductive medium of claim 18, wherein said poly(amic acid)-compatible solvent is chosen from the group consisting of N-methylpyrrolidone, N,N-dimethylformamide, N,N-dimethylacetamide and M-ethylpyrrolidone.

20. The anhydrous, proton-conductive medium of claim 18, wherein said poly(amic acid)-compatible solvent comprises N-methylpyrrolidone.

21. The anhydrous, proton-conductive medium of claim 18, wherein said poly(amic acid)-compatible solvent comprises a precursor solvent from which said poly(amic acid) has been formed.

22. A process for forming an anhydrous, proton-conductive medium, the process comprising
mixing a phosphorus oxide in a poly(amic acid) solution to form a mixture;
dispensing said mixture upon a support structure; and
substantially drying said mixture.

23. The process of claim 22, further comprising curing said mixture after drying.

24. The process of claim 22, further comprising mixing said phosphorus oxide and said poly(amic acid) with a poly(amic acid)-compatible solvent to form said mixture.

25. The process of claim 22, wherein said poly(amic acid) is an aromatic poly(amic acid).

26. The process of claim 22, wherein said poly(amic acid) is an aliphatic poly(amic acid).

27. The process of claim 22, wherein said phosphorus oxide has the formula PₓO_{y}, with x=1 to 4 and y=4 to 10.

28. The process of claim 22, wherein said phosphorus oxide has the formula P₄O₁₀.

29. The process of claim 22, wherein the step of mixing a phosphorus oxide in a poly(amic acid) solution to form a mixture comprises first pre-dissolving said phosphorus oxide in a poly(amic acid)-compatible solvent.

30. The process of claim 29, wherein said poly(amic acid)-compatible solvent is chosen from the group consisting of N-methylpyrrolidone, N,N-dimethylformamide, N,N-dimethylacetamide and N-ethylpyrrolidone.

31. The process of claim 29, wherein said poly(amic acid)-compatible solvent comprises N-methylpyrrolidone.

32. The process of claim 29, wherein said poly(amic acid)-compatible solvent comprises a solvent from which said poly(amic acid) has been formed.
